(19) United States
(12) Patent Application Publication
(10) Pub. No.: US 2004/0016819 A1
(43) Pub. Date: Jan. 29, 2004

(54) Apparatus and method for generating a treatment fluid and application thereof

(76) Inventors: Kerry Maxwell Scott, Western Australia (AU); Maxwell Edney Scott, Western Australia (AU)

Correspondence Address: DOUGHERTY, CLEMENTS & HOFER, 1901 ROXBOROUGH ROAD, SUITE300, CHARLOTTE, NC, 28211, US

(21) Appl. No.: 10/149,739

(22) PCT Filed: Dec. 11, 2000
(86) PCT No.: PCT/AU00/01527

(30) Foreign Application Priority Data
Dec. 10, 1999 (AU) PQ4600

(51) Int. Cl. B05B 1/24

(52) U.S. Cl. 239/135

(57) ABSTRACT

Apparatus for, and a method of, generating a treatment substance. The method is performed using apparatus (10) and comprise steps of creating a supply of hot water (11); creating a supply of compressed air (15); and delivering a stream of the hot water and a stream of the compressed air to a nozzle (21). The hot water and the compressed air are mixed in a mixing chamber (30) in the nozzle (21) to create a treatment fluid. The treatment fluid is discharged under pressure through an outlet (35) in the nozzle.

### FIELD OF THE INVENTION

This invention relates to apparatus for, and a method of, generating a treatment fluid. The invention also relates to applications for the treatment fluid, including vegetation control, and sterilisation of surfaces and substances such as soil.

### BACKGROUND ART

The invention has been devised particularly, although not, solely, for eradicating weeds in urban environments. The invention can, however, have other application, including, for example, treatment of ground soil for purposes such as sterilisation, and for killing insects.

In relation to vegetation control, it is customary to rely on the application of chemicals. Controlling vegetation, and in particular weeds, in this way can, however, have an adverse affect on the environment, including the ground, the atmosphere, and life-forms in the vicinity.

A known form of vegetation control without the use of chemicals involves application of hot water to vegetation in order to kill it. This procedure has not proved particularly satisfactory as it is uneconomical owing to the slow rate at which hot water needs to be applied in order to be effective.

A somewhat related procedure involved the application of hot foam to the vegetation. This also has not proved to be particularly successful commercially as the presence of foam on the ground is not aesthetically pleasing and has potential for damaging effects on the environment.

Another proposal for vegetation control involves the application of hot air or flame to the vegetation. This procedure is not particularly effective as it in fact only scorches the exposed part of the vegetation and does not effectively kill the vegetation. It also has the potential to create a fire hazard.

It is against the above background, and the problems and deficiencies associated therewith, that the present invention has been developed.

### DISCLOSURE OF THE INVENTION

The present invention provides an apparatus for generating a treatment fluid, comprising a nozzle structure having a mixing chamber and an outlet, a means for introducing a supply of hot water into the mixing chamber in a flow direction towards the outlet, and a means for introducing a supply of air under pressure into the mixing chamber in a flow direction towards the outlet, whereby the air and hot water undergo mixing in the mixing chamber with the mixture discharging under pressure through the outlet as the treatment fluid.

The treatment fluid may be used for controlling vegetation by application of the treatment fluid to the vegetation.

The treatment fluid may be used for sterilising soil by application of the treatment fluid to the soil. The fluid may also be used for sterilising a surface by application of the treatment fluid to the surface.

Preferably, the hot water is introduced into the mixing chamber at a pressure less than the pressure at which the air is introduced into the mixing chamber.

Preferably, the nozzle structure comprises an elongate body having the outlet at one end thereof and an inlet at the other end thereof to receive the water, the mixing chamber being defined between the inlet and the outlet, and a further inlet being provided for introducing the air into the mixing chamber. Preferably, the further inlet is configured to direct the air entering the mixing chamber into the flow of water therein.

The body may be in the form of a lance or wand which can be manually held and operated.

Preferably, the hot water is delivered to the body along a flexible hot water line.

Preferably, the air under pressure is delivered to the body along a flexible air line.

The treatment fluid preferably discharges from the nozzle structure at a temperature greater than 85G. Typically, the temperature is in the range 98C to 104C.

Preferably, the hot water introduced into the mixing chamber is at a temperature exceeding 85C and less than the boiling point of the water. Typically, the water is at a temperature of about 110C.

The apparatus may further include means for generating hot water for delivery to the nozzle, and means for generating compressed air for delivery to the nozzle.

Conveniently, the means for generating hot water and the means for generating hot air are electrically operable and the apparatus further includes a power supply for providing electrical power to operate the means for generating hot water and the means for generating compressed air.

Conveniently, the air is introduced into the mixing chamber at a flow rate of between about 85 and 200 cubic decimetres per minute (3 to 7 cubic feet per minute), and preferably at a rate of about 142 cubic decimetres per minute (5 cubic feet per minute).

Conveniently, the hot water is introduced into the mixing chamber at a flow rate of about 8 litres per minute to 15 litres per minute with a flow rate of 13 litres per minute being preferred.

The present invention also provides an apparatus for treating vegetation, the apparatus being as defined hereinbefore.

The present invention also provides an apparatus for sterilising soil or some other substance or surface, the apparatus being as defined hereinbefore.

The present invention also provides apparatus for killing insects, such as for example locusts, the apparatus being as defined hereinbefore.

The invention also provides a method of generating a treatment fluid comprising steps of: providing a nozzle having a mixing chamber and an outlet; creating a supply of hot water; creating a supply of compressed air; delivering a stream of hot water from the hot water supply into the mixing chamber in a flow towards the outlet; and delivering a stream of compressed air from the compressed air supply into the mixing chamber in a flow towards the outlet whereby the hot water and the compressed air mix in the mixing chamber to create a treatment fluid; and discharging the treatment fluid through the outlet in the nozzle.

Preferably, the hot water is delivered to the nozzle at low pressure and in particular at a pressure less than the pressure of air delivered to the nozzle. The invention also provides a method of treating vegetation comprising steps of: providing a nozzle having a mixing chamber and an outlet; creating a supply of hot water; creating a supply of compressed air; delivering a stream of hot water from the hot water supply into the mixing chamber in a flow towards the outlet; and delivering a stream of compressed air from the compressed air supply Into the mixing chamber in a flow towards the outlet, whereby the hot water and the compressed air mix in the mixing chamber to create a treatment fluid: and discharging the treatment fluid through the outlet in the nozzle and onto the vegetation.

The invention also provides a method of vegetation control comprising the steps of generating a treatment fluid comprising a mixture of water and air at a temperature exceeding about 85C and applying the treatment fluid to vegetation to be controlled.

The invention also provides a method of applying a treatment fluid to a surface comprising steps of: providing a nozzle having a mixing chamber and an outlet; creating a supply of hot water; creating a supply of compressed air; delivering a stream of hot water from the hot water supply into the mixing chamber in a flow towards the outlet; and delivering a stream of compressed air from the compressed air supply into the mixing chamber in a flow towards the outlet, whereby the hot water and the compressed air mix in the mixing chamber to create a treatment fluid; and discharging the treatment fluid through the outlet in the nozzle and onto the surface.

### BRIEF DESCRIPTION OF THE DRAWINGS

The invention will be better understood by reference to the following description of one specific embodiment thereof as shown in the accompanying drawings in which:

FIG. 1 is a schematic view of apparatus according to the embodiment; and

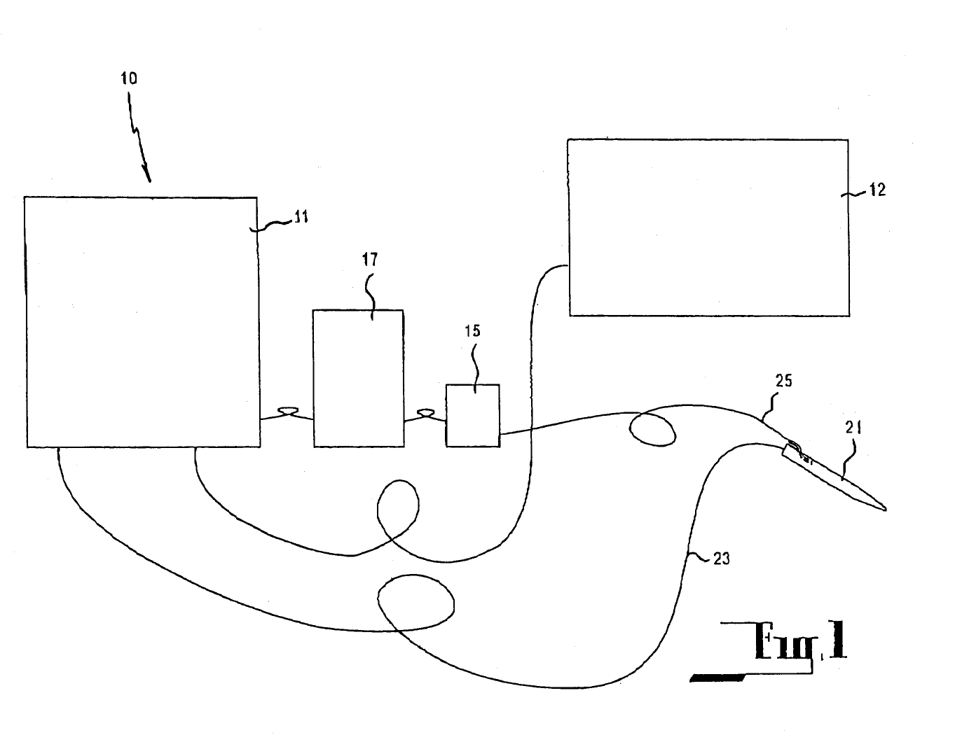

FIG. 2 is a schematic view of a lance which forms part of the apparatus of FIG. 1.

### BEST MODE(S) FOR CARRYING OUT THE INVENTION

The embodiment shown in the drawings is directed to an apparatus 10 for generating a treatment fluid which can be used for various purposes, one being vegetation control another being sterilisation of topsoil, and still another being killing of insects such as locusts.

The apparatus 10 comprises a mobile structure (not shown) which carries a supply of hot water 11 and a reservoir 12 for replenishing water extracted from the supply 11. The mobile structure also supports an air compressor 15 for providing a supply of compressed air. The supply of hot water 11 and the air compressor 15 are both electrically operable and receive electrical power from a power supply 17 which is also carried on the mobile structure.

The apparatus further includes nozzle in the form of a hand-held lance 21 which is controlled by an operator working in association with the mobile structure. The lance 21 is connected to the hot water supply 11 by way of a flexible hot water delivery line 23. The lance 21 is also connected to the air compressor 15 by way of a flexible air line 25.

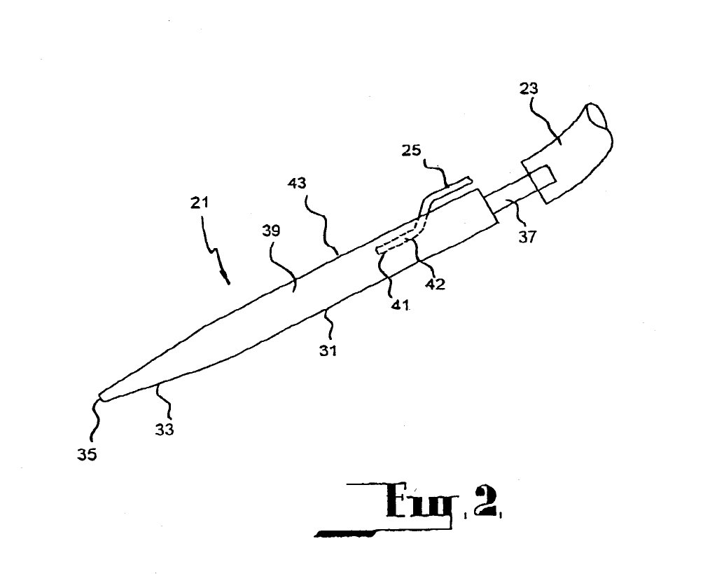

As is seen in FIG. 2 of the drawings, the lance 21 comprises an elongate body 31 of generally circular cross section. One end of the body 31 has an inwardly tapering spout section 33 terminating at a discharge outlet 35. The other end of the body 31 is provided with a first Inlet 37 to which the hot water delivery line 23 is connected.

A mixing chamber 39 is defined within the body 31 between the ends thereof.

A second inlet 41 opens into the mixing chamber 39. The second inlet al is defined by an end section 42 of the air delivery hose 25 which extends through the side wall 43 of the body 31. The end section 42 is arranged so as to direct air issuing from the inlet 41 In a direction towards the outlet 35, as shown in FIG. 2 of the drawings. As is apparent from FIG. 2, the second inlet 41 is disposed inwardly of the longitudinal side wall of the mixing chamber 39 such that air issuing from the inlet 41 enters the water flow issuing from the first inlet 37.

The water is delivered into the mixing chamber 39 at low pressure and in particular at a pressure less than the pressure at which air is delivered Into the mixing chamber. This is to ensure that water does not escape via the air line 25.

In this embodiment, compressed air is delivered into the mixing chamber 39 along the air delivery line 25 at a rate of between about 85 and 200 cubic decimetres per minute (about 3 to 7 cubic feet per minute), with the preferred rate being about 142 cubic decimetres per minute (5 cubic feet per minute). Water at a temperature of about 100C to 110C is delivered from the supply 11 into the mixing chamber 39 along water delivery line 23 at a rate of between 15 litres per minute, with a rate of 13 litres per minute being preferred.

It has been found that these air and water flow rates permit effective and economical operation of the apparatus 10, without the need to carry an excessively large volume of water and to incur high heating costs.

The mixing chamber 39 in this embodiment has an external diameter of about 19 millimetres and an internal diameter of about 75% of the external diameter. The length is between 750 millimetres and 1 metre The outlet 35 in the spout section 33 is in the form of a hole of a diameter of about 1.5 millimetres.

In operation, hot water and air delivered separately to the lance 21 are mixed together in the treatment chamber 39 to form a treatment fluid which discharges under pressure through the outlet 35.

The hot water delivered to the mixing chamber 39 is at a temperature less than its boiling point, and typically is about 100C to 110C.

The treatment fluid discharging through the outlet 35 is at a temperature of about 98C to 104C. For very effective vegetation control, it is important for the temperature of the treatment fluid to exceed about 85C.

The operator controls the direction of the discharging treatment fluid by manipulating the lance 21 as necessary.

The treatment fluid can be used for vegetation control in which case the treatment fluid is sprayed onto the vegetation which is to be killed. Seeds in the top soil adjacent ground level are also likely to be killed.

In another application, the treatment fluid can be used to sterilise topsoil, in which case the treatment fluid is simply sprayed onto the soil requiring treatment.

The combination of hot water and compressed air forming the treatment fluid provides unexpected results In its effectiveness in vegetation control and sterilisation It is believed that the presence of moisture in the treatment fluid is very effective in delivery of heat to the vegetation or soil, and assists in penetration of the heat into the plant structure of the vegetation and also in the soil.

While the combination of the hot water and the air under pressure when mixed together provides a treatment fluid which is particularly effective in vegetation control and soil sterilisation, it should be appreciated that the treatment fluid may not necessarily be limited to such applications.

It should also be appreciated that the scope of the invention is not limited to the scope of the embodiment described.

Throughout the specification, unless the context requires otherwise, the word “comprise” or variations such as “comprises” or “comprising”, will be understood to imply the inclusion of a stated integer or group of integers but not the exclusion of any other integer or group of integers.

The claims Defining the Invention are as Follows

1. An apparatus for generating a treatment fluid, comprising a nozzle structure having a mixing chamber and an outlet, a means for introducing a supply of hot water into the mixing chamber in a flow direction towards the outlet, and a means for introducing a supply of air under pressure into the mixing chamber in a flow direction towards the outlet, whereby the air and hot water undergo mixing in the mixing chamber with the mixture discharging under pressure through the outlet as the treatment fluid.

2. Apparatus according to claim 1 wherein the hot water is introduced into the mixing chamber at a pressure less than the pressure at which the air is introduced into the mixing chamber.

3. Apparatus according to claim 1 wherein the nozzle structure comprises an elongate body having the outlet at one end thereof and an inlet at the other end thereof to receive the water, the mixing chamber being defined between the inlet and the outlet, and a further inlet being provided for introducing the air into the mixing chamber.

4. Apparatus according to claim 3 wherein the further inlet is configured to direct the air entering the mixing chamber into the flow of water therein.

5. Apparatus according to claim 3 wherein the body comprises a lance or wand which can be manually held and operated.

6. Apparatus according to claim 3 wherein the hot water is delivered to the body along a flexible hot water line.

7. Apparatus according to claim 3 wherein the air under pressure is delivered to the body along a flexible air line.

8. Apparatus according to claim 1 wherein the treatment fluid discharges from the nozzle structure at a temperature greater than 85° C.

9. Apparatus according to claim 8 wherein the temperature is in the range 98° C. to 104° C.

10. Apparatus according to claim 1 wherein the hot water introduced into the mixing chamber is at a temperature exceeding 85° C. and less than the boiling point of water.

11. Apparatus according to claim 10 wherein the water is at a temperature of about 110° C.

12. Apparatus according to claim 1 further comprising means for generating hot water for deliver to the nozzle, and means for generating compressed air for delivery to the nozzle.

13. Apparatus according to claim 12 wherein the means for generating hot water and the means for generating hot air are electrically operable, and the apparatus further includes a power supply for providing electrical power to operate the means for generating hot water and the means for generating compressed air.

14. Apparatus according to claim 1 wherein the air is introduced into the mixing chamber at a flow rate of between about 85 and 200 cubic decimetres per minute.

15. Apparatus according to claim 1 wherein the hot water is introduced into the mixing chamber at a flow rate of about 8 litres per minute to 15 litres per minute.

16. CANCELLED.

17. CANCELLED.

18. CANCELLED.

19. A method of generating a treatment fluid comprising steps of: providing a nozzle having a mixing chamber and an outlet; creating a supply of hot water; creating a supply of compressed air; delivering a stream of hot water from the hot water supply into the mixing chamber in a flow towards the outlet; and delivering a stream of compressed air from the compressed air supply into the mixing chamber in a flow towards the outlet, whereby the hot water and the compressed air mix in the mixing chamber to create a treatment fluid; and discharging the treatment fluid through the outlet in the nozzle.

20. A method according to claim 19 wherein the hot water is delivered to the nozzle at a pressure less than the pressure of air delivered to the nozzle.

21. A method according to claim 19 wherein the treatment fluid discharging through the outlet in the nozzle is at a temperature greater than 85° C.

22. A method according to claim 21 wherein the temperature is in the range 98° C. to 104° C.

23. A method according to claim 19 wherein the hot water introduced into the mixing chamber is at a temperature exceeding 85° C. and less than the boiling point of the water.

24. A method according to claim 19 wherein the air is introduced into the mixing chamber at a flow rate between about 85 and 200 cubic decimetres per minute.

25. A method according to claim 19 wherein the water is introduced into the mixing chamber at a flow rate of about 8 to 15 litres per minute.

26. A method of vegetation control comprising the steps of generating a treatment fluid comprising a mixture of water and air at a temperature exceeding about 85° C. and applying the treatment fluid to vegetation to be controlled.

27. A method according to claim 26 wherein the temperature is in the range 98° C. to 104° C.

28. A method according to claim 26 wherein the hot water mixed with the air is at a temperature exceeding 85° C. and less than the boiling point of the water.

29. A method according to claim 26 wherein the hot water and air are mixed in a mixing chamber.

30. A method according to claim 29 wherein the air is introduced into the mixing chamber at a flow rate between about 85 to 200 cubic decimetres per minute.

31. A method according to claim 29 wherein the water is introduced into the mixing chamber at a flow rate of about 8 to 15 litres per minute.

32. A method of treating vegetation comprising steps of: providing a nozzle having a mixing chamber and an outlet; creating a supply of hot water; creating a supply of compressed air; delivering a stream of hot water from the hot water supply into the mixing chamber in a flow towards the outlet; and delivering a stream of compressed air from the compressed air supply into the mixing chamber in a flow towards the outlet, whereby the hot water and the compressed air mix in the mixing chamber to create a treatment fluid; and discharging the treatment fluid through the outlet in the nozzle and onto the vegetation.

33. A method of applying a treatment fluid to a surface comprising steps of: providing a nozzle having a mixing chamber and an outlet; creating a supply of hot water; creating a supply of compressed air; delivering a stream of hot water from the hot water supply into the mixing chamber in a flow towards the outlet; and delivering a stream of compressed air from the compressed air supply into the mixing chamber in a flow towards the outlet, whereby the hot water and the compressed air mix in the mixing chamber to create a treatment fluid; and discharging the treatment fluid through the outlet in the nozzle and onto the surface.

34. CANCELLED.

35. CANCELLED.

36. CANCELLED.
